(19) United States
(12) Patent Application Publication
(10) Pub. No.: US 2012/0013576 A1
(43) Pub. Date: Jan. 19, 2012

(54) PIEZO-TYPE SCANNING APPARATUS AND TOUCH SCREEN USING THE SAME

(75) Inventors: Il Kwon Chung, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/887,790

(22) Filed: Sep. 22, 2010

(30) Foreign Application Priority Data
Jul. 14, 2010 (KR) 1020100068070

(51) Int. Cl. G06F 3/042; G02B 26/10

(52) U.S. Cl. 345/175; 359/226.2

(57) ABSTRACT

Disclosed herein are a piezo-type scanning apparatus and a touch screen using the same. The preferred embodiments of the present invention provides the scanning apparatus including a light source; an optical fiber of which one end is connected to the light source to provide a transmission line; a support that supports the side surface of the optical fiber; and a driving body that is positioned between the support and the light source to provide driving force rotating the optical fiber using piezoelectric force, and the touch screen using the same.

### CROSS REFERENCE TO RELATED APPLICATION

This application claims the benefit of Korean Patent Application No. 10-2010-0068070, filed on Jul. 14, 2010, entitled “Piezo-Type Scanning Apparatus And Touch Screen Using Its”, which is hereby incorporated by reference in its entirety into this application.

### BACKGROUND OF THE INVENTION

1. Technical Field

The present invention relates to a piezo-type scanning apparatus and a touch screen using the same.

2. Description of the Related Art

When an image to be displayed on a screen is touched by a finger, a touch pen, or the like, a touch screen is an apparatus capable of appreciating a touched point in response to the touch.

A touch screen is generally manufactured to have a structure in which it is covered on a flat panel display, such as an LCD panel, or a PDP panel. The touch screen is an apparatus that senses a position touched by a finger, separately from an image to be displayed on a screen, to calculate it into coordinates on the image screen, wherein the coordinate information is transmitted to a computer that controls an image.

The computer controls the image so as to properly respond by synthesizing the position information received from the touch screen and the image screen.

The touch screen may be implemented through several methods technically different according to the size and usage of the screen. As a typical example, there are a resistive type, an electrostatic type, a surface acoustic wave type, an infrared beam type, a camera (or optical) type, and the like.

FIG. 1 is a configuration diagram of a general camera type touch screen according to the prior art.

As shown in FIG. 1, in the camera type touch screen according to the prior art, compact cameras 3 that monitor a screen, with an angle of view of 90°, are each installed at both ends of one side of a rectangular frame 2 that supports a display panel 1, a plurality of infrared LEDs 4 are densely arranged on the other three sides of the rectangular frame 2 as a light source emitting infrared rays, and a control board 5 that controls the driving of the cameras 3 and the infrared LEDs 4 and analyzes an image sensed by the cameras 3 to detect a touched point is installed on one side of the frame 2 or the inner side of the display apparatus on which the touch screen is installed.

In the touch screen constituted as above, the plurality of LEDs 4 arranged on three sides of the rectangular frame 2 emit infrared rays and the cameras 3 installed at two edges thereof receive the infrared rays emitted from the infrared LEDs 4. In this case, if the display panel 1 is touched by a user's finger (or a touch pen), a path that the infrared rays emitted from the three sides of the frame 2 reaches the cameras 3 is partially blocked.

The two cameras 3 senses shadows generated by the finger at each different position at a camera angle, and the control board 5 processes the information on the camera angle obtained from the two cameras 3 to calculate the touched point into coordinates.

The coordinate information calculated by the control board 5 is transmitted to a computer that controls the display apparatus and the computer allows the coordinates of the touched point to be displayed on the screen which corresponds to the image on the screen.

In the camera type touch screen according to the prior art having the configuration and operation as described above, the plurality of infrared LEDs are densely arranged on three sides of the rectangular frame constituting a screen, such that the installation process is complicated and difficult, and as a result, the installation costs are also expensive.

### SUMMARY OF THE INVENTION

The present invention has been made in an effort to provide a scanning apparatus using a piezo method, which is easily manufactured at low costs, instead of a plurality of infrared LEDs, and a touch screen using the same.

A scanning apparatus according to a preferred embodiment of the present invention includes: a light source that generates and emits light; an optical fiber of which one end is connected to the light source to provide a transmission line through which the light emitted from the light source is transmitted; a support that supports the side surface of the optical fiber to provide a rotation shaft so that the optical fiber is rotated; and a driving body that is positioned between the support and the light source to provide driving force rotating the optical fiber using piezoelectric force.

The scanning apparatus further includes a detector that is installed adjacent to the light source and receives light reflected from an object of which distance is to be measured through the optical fiber to measures and output a distance.

The support is formed of a plate-shaped supporting plate that has a hole through which the optical fiber penetrates, wherein the supporting plate formed around the hole supports the side surface of the optical fiber to rotate the optical fiber.

The support is formed of a plurality of supporting blocks spaced apart from each other having a gap through which the optical fiber penetrates, wherein the supporting blocks have a concave shape on a surface opposite to a surface through which the optical fiber penetrates.

The driving body includes a substrate; and a piezo driving body that is stacked on the substrate and provides driving force by the piezoelectric force.

The piezo driving body includes: a first electrode layer that is stacked on the substrate, the first electrode layer being made of a conductive material; a piezo layer that is stacked on the first electrode layer, the piezo layer being made of a piezo material; and a second electrode layer stacked on the piezo layer, the second electrode layer being made of a conductive material.

A touch screen according to a preferred embodiment of the present invention includes: a display panel that emits light and implements an image; a first scanning apparatus that emits light periodically scanned over the surface of the display panel to the display panel in parallel and adjacent thereto; and a first detector that receives light reflected or scattered from the touch input member in contact or adjacent to the display panel to calculate and output a distance, wherein the first scanning apparatus includes: a first light source that generates and emits light; a first optical fiber of which one end is connected to the first light source to provide a transmission line through which the light emitted from the light source is transmitted; a first support that supports the side surface of the first optical fiber to provide a rotation shaft so that the first optical fiber is rotated; and a first driving body that is positioned between the first support and the first light source to provide driving force rotating the first optical fiber using piezoelectric force.

The touch screen further includes a second detector that receives the light reflected or scattered from the touch input member in contact or adjacent to the display panel to calculate and output a distance.

The first detector is installed in the first scanning apparatus to be adjacent to the first light source and receives reflection light from the touch input member through the first optical fiber to measure and output the distance of the touch input member.

The first driving body includes: a substrate; a first electrode layer that is stacked on the substrate, the first electrode layer being made of a conductive material; a piezo layer that is stacked on the first electrode layer, the piezo layer being made of a piezo material; and a second electrode layer stacked on the piezo layer, the second electrode layer being made of a conductive material.

The touch screen further includes a signal processor that confirms the distance of the touch input member output from the first detector and the emission angle of the first scanning apparatus to determine the position of the touch input member.

The touch screen further includes a second scanning apparatus that is spaced apart from the first scanning apparatus and emits light periodically scanned over the display panel to the display panel in parallel and adjacent thereto, wherein the second scanning apparatus includes: a second light source that generates and emits light; a second optical fiber of which one end is connected to the second light source to provide a transmission line through which the light emitted from the light source is transmitted; a second support that supports the side surface of the second optical fiber to provide a rotation shaft so that the second optical fiber is rotated; and a second driving body that is positioned between the second support and the second light source to provide driving force rotating the second optical fiber using piezoelectric force.

The touch screen further includes a third detector that is spaced apart from the first detector and receives the light reflected or scattered from the touch input member in contact or adjacent to the display panel to calculate and output the distance of the touch input member.

The third detector is installed in the second scanning apparatus to be adjacent to the second light source and receives incident light through the second optical fiber to measure and output the distance of the touch input member.

The touch screen further includes a signal processor that confirms the distance of the touch input member output from the first detector and the third detector and the emission angle of the first scanning apparatus and the second scanning apparatus to determine the position of the touch input member.

### BRIEF DESCRIPTION OF THE DRAWINGS

FIG. 1 is a configuration diagram of a general camera type touch screen according to the prior art;

FIG. 2 is a perspective view of a piezo-type scanning apparatus according to a first embodiment of the present invention;

FIG. 3 is a cross-sectional view of the piezo-type scanning apparatus according to the first embodiment of the present invention;

FIG. 4 is an exemplification diagram showing a rotation of the optical fiber of FIG. 2;

FIG. 5 is a diagram showing another embodiment of the support of FIG. 2;

FIG. 6 is a detailed configuration diagram of the driver of FIG. 2;

FIG. 7 is a configuration diagram of a touch screen using the scanning apparatus according to the first embodiment of the present invention;

FIG. 8 is a diagram showing distance signals according to a first embodiment of the present invention;

FIG. 9 is a detailed configuration diagram of a scanning apparatus including the electronic equipment of FIG. 7;

FIG. 10 is a configuration diagram of a touch screen using a scanning apparatus according to a second embodiment of the present invention;

FIG. 11 is a configuration diagram of a touch screen using a scanning apparatus according to a third embodiment of the present invention; and

FIG. 12 is a configuration diagram of a touch screen using a scanning apparatus according to a fourth embodiment of the present invention.

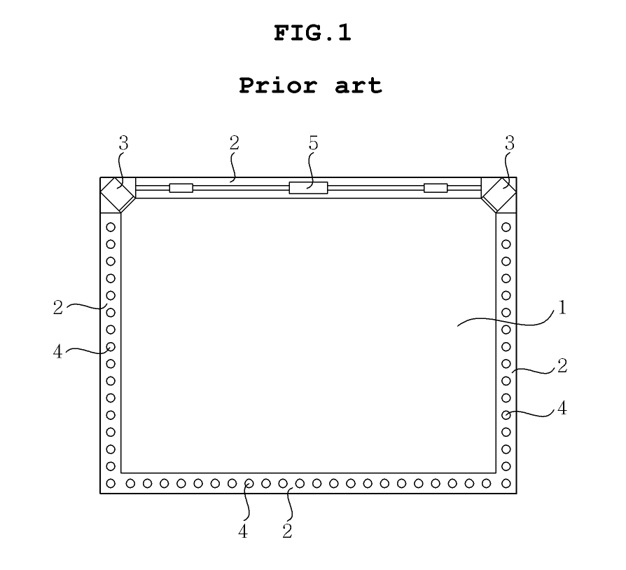

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that a detailed description of the known art related to the present invention may obscure the gist of the present invention, the detailed description thereof will be omitted.

Hereinafter, preferred embodiments of the present invention will be described in detail with reference to the accompanying drawings.

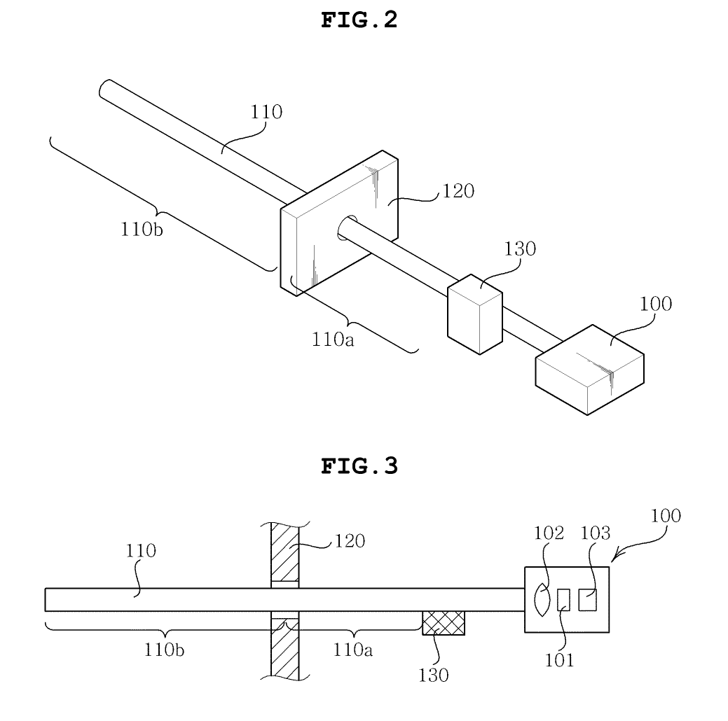

FIG. 2 is a perspective view of a piezo-type scanning apparatus according to a first embodiment of the present invention, and FIG. 3 is a cross-sectional view of the piezo-type scanning apparatus according to the first embodiment of the present invention.

Referring to FIGS. 2 and 3, the piezo-type scanning apparatus according to the first embodiment of the present invention is configured to include a light source and detecting unit 100, an optical fiber 110, a support 120, and a driving body 130.

Herein, the light source and detecting unit 100 includes a light source 101, a lens 102, and a detector 103.

In the light source and detecting unit 100, the light source 101 generates and emits light, wherein a light source, formed of a semiconductor, such as a Vertical External Cavity Surface Emitting Laser (VECSEL), a Cavity Surface Emitting Laser (VCSEL), a Light Emitting Diode (LED), a Laser Diode (LD), a Super Luminescent Diode (SLED), or the like, may be used.

The lens 102, which improves linearity and straightness of the light emitted from the light source 101, may be a collimate lens or the like.

The detector 103 receives the light that is scattered and reflected from the frame of the display panel, an object of which distance is to be measured, and a touch input member such as a finger or the like, to calculate and output a distance to the frame or the touch input member, wherein the scattered and reflected light is the light emitted from the light source 101.

In this configuration, when a laser diode is used as the light source 101, the laser diode may be used as the detector 103.

More specifically, when the light emitted from the light source 101 is scattered from the touch input member to be incident on the laser diode, the light output from the laser diode is subject to modulation (undulation) due to the incident light.

Such a modulation is detected by monitoring the output voltage from the laser diode through a photodiode, another constituent, and the detector 103 calculates a distance between the laser diode and the position from which the light is reflected using the detected modulation.

In this case, the detector 103 may be configured of the laser diode, the photodiode, or the like. Subsequently, the detector 103 receives the light reflected from the object of which distance is to be measured to measure and output the distance.

The distance measurement based on the laser selfmxing described above is well-known and thus a detailed description thereof will be omitted.

Meanwhile, the optical fiber 110, which is a transmission line through which the light emitted from the light source 101 of the light source and detecting unit 100 is transmitted, may use a silica-based optical fiber, a fluorinated optical fiber, a rare earth based optical fiber, a plastic cladding optical fiber, a plastic optical fiber, or the like.

The optical fiber 110 scans the light emitted from the light source 101 on the surface of the touch screen, while moving horizontally by driving the driving body 130. Therefore, the optical fiber 110 should have a predetermined stiffness to prevent excessive bending, thereby increasing accuracy.

Then, the support 120 is formed in a plate shape and has a hole provided therein, wherein the optical fiber 110 penetrates through the provided hole.

The support 120 is to generate a seesaw effect for optimizing a movement effect when the optical fiber 110 is moved (rotated) horizontally by horizontal driving force provided from the driving body 130.

The support 120 formed around the hole supports the portion through which the optical fiber 110 penetrates to allow a portion 110a of the optical fiber 110 before penetrating through the hole and a portion 110b of the optical fiber 110 after penetrating through the hole to be operated in the opposite direction.

As a result, the rotation distance is doubled according to the ratio of the distance of the portion 110a of the optical fiber 110 before penetrating through the hole and the distance of the portion 110b thereof after penetrating through the hole.

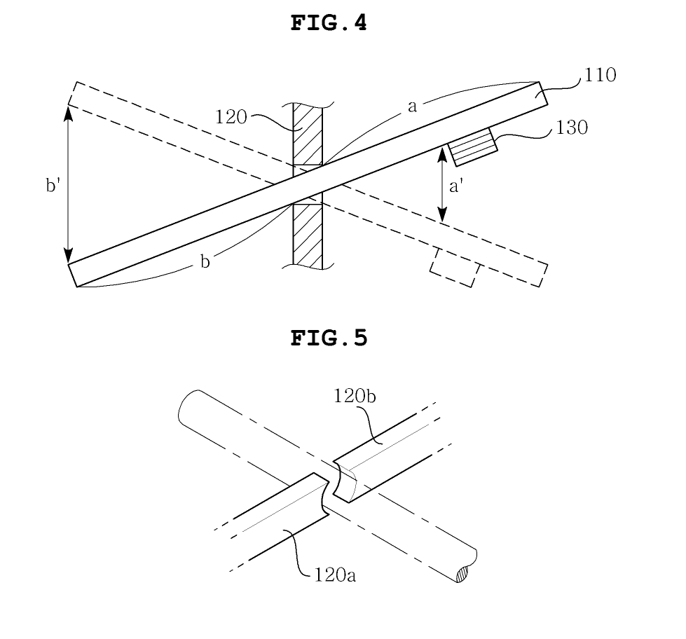

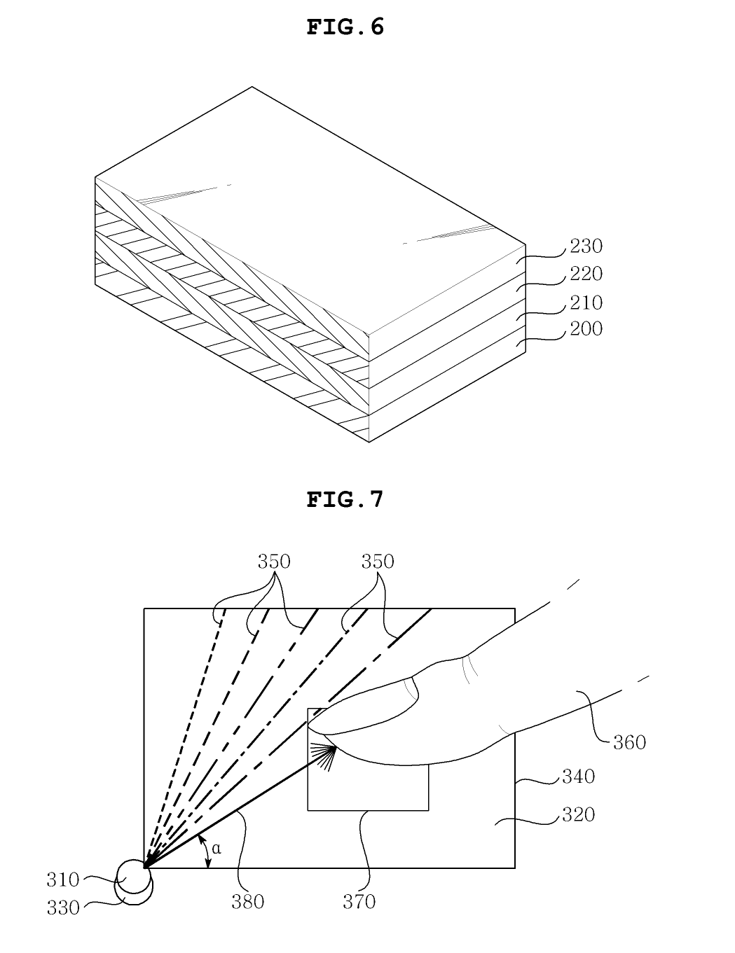

In other words, referring to FIG. 4 showing such a relationship, when the distance of the portion 110a of the optical fiber 110 before penetrating through the hole is represented by a, the distance of the portion 110b thereof after penetrating through the hole is represented by b, the rotation distance of the corresponding portion of the optical fiber 110 in contact with the driving body 130 is represented by a′, and the rotation distance of the distal end of the optical fiber 110 is represented by b′, Equation 1 below is made, such that the rotation distance is doubled according to the ratio of the distances.

[Equation 1]

$${b}^{′} = {a}^{′} \frac{b}{a}$$

Meanwhile, the support 120 uses a plate-shaped supporting plate herein. However, as shown in FIG. 5, the support 120 may also be implemented by using two supporting blocks 120a and 120b that are spaced apart from each other, having a gap through which the optical fiber 110 penetrates therebetween, and are formed concave, which are positioned at the surface opposite to the surface through which the optical fiber 110 penetrates.

Then, the driving body 130 generates horizontal driving force and transfers the horizontal driving force to the optical fiber 110 in contact, thereby moving the optical fiber 110 horizontally. The driving body 130 is configured to include a substrate 200 and piezo driving body 210 to 230.

In this case, the substrate 200 is a semiconductor substrate generally used. As a material constituting the substrate 200, silicon Si, alumina Al₂O₃, zirconia (ZrO₂), quartz, silica (SiO₂), or the like may be used.

The piezo driving body 210 to 230 generate driving force for horizontally moving the contact portion of the optical fiber 110 according to a piezoelectric method, and are configured of a lower electrode layer 210, a piezo layer 220 stacked on the lower electrode layer 210, and an upper electrode layer 230 stacked on the piezo layer 220.

In this case, as an electrode material of the lower or the upper electrode layer 210 or 230, platinum (Pt), nickel (Ni), gold (Au), aluminum (Al), titanium (Ti), IrO₂, RuO₂, or the like may be used and any one of the combination thereof may be used.

The lower or the upper electrode layer 210 or 230 may be formed by sputtering or vacuum evaporation.

The piezo layer 220 may be formed on the lower electrode layer 210 by wet etching and dry etching. In this case, as the piezo layer 220, a piezo material such as PZT, PNNPT, PLZT, AlN, ZnO, or the like may be used, and a piezo material constituted by including at least one element such as lead (Pb), zirconium (Zr), zinc (Zn), titanium (Ti) or the like may be used.

When voltage is applied to the lower electrode layer 210 and the upper electrode layer 230, the piezo driving body 210 to 230 generates driving force as the piezo layer 220 is contracted or expanded and horizontally moves the contact portion of the optical fiber 110 in response to the generated driving force.

Meanwhile, in the light source and detecting unit 100, the detector 103 is formed integral with the light source 101. However, they may be implemented as separate devices and the detector 103 may be also installed at a distant position from the light source 101.

FIG. 7 is a configuration diagram of a touch screen using the scanning apparatus according to the first embodiment of the present invention.

Referring to FIG. 7, the touch screen using the scanning apparatus according to the first embodiment of the present invention is configured to include a scanning apparatus 310 that generate light and emits the light periodically scanned on the surface of a display panel 320, the display panel 320 that implements an image by emitting light and has a frame 340 reflecting or scattering the light 350 or 380 emitted from the scanning apparatus 310, and a detector 330 that receives the reflected light to calculate and output the distance to an object of which distance is to be measured (frame or touch input member).

In this case, it is preferable that the scanning apparatus 310 is disposed at one edge of the frame 340. The scanning apparatus 310 emits the light periodically scanned right on the surface of the entire display panel 320, such that the surface of the display panel 320 is periodically scanned by light 350 or 380.

The light 350 or 380 is emitted to the plane right on the surface of the display panel 320 to be stopped by a touch input member in contact with the surface of the display panel 320 or adjacent thereto.

The light 350 or 380 is indicated as 350 when it ends on the frame 340 of the display panel 320. The light 350 or 380 is indicated as 380 at the moment when it is scattered from the touch input member. Two reference numerals 350 and 380 are referred to as the same light at different moments.

For example, if the display panel 320 is not touched by a touch input member such as a user's finger 360, the light 350 is reflected or scattered from the frame 340 of the display panel 320.

Meanwhile, the detector 330 receives the light reflected or scattered from the touch input member in contact with the display panel 320 or adjacent thereto, thereby calculating and outputting the distance.

Such a detector 330 may be installed inside the scanning apparatus 310 or adjacent thereto. The detector 330 may also be installed to be spaced apart from the scanning apparatus 310.

In this configuration, as a light source included in the scanning apparatus 310, a laser diode, which is a portion of the detector 330, may be used in detecting the scattered light again, as described above. In this case, the light output from the laser diode is subject to modulation (undulation) due to the scattered light. Such modulation is detected by monitoring the output power from the laser diode through another constituent constituting the detector 330, such as a photodiode.

Since the laser diode itself is current-modulated, such a result may be used in measuring a distance between the laser diode and the position at which the light 350 is reflected.

In other words, the detector 330 calculates and outputs the distance between the laser diode and the position at which the light 350 is reflected by detecting and using the output power from the laser diode.

Meanwhile, when the display panel 320 is not in contact with any touch input member 360, the distance between the scanning apparatus 310 and the position of the frame 340 indicated by the light is measured and output by the detector 330 receiving the light scattered again.

When the display panel 320 is in contact with the touch input member 360, for example, a specific point such as lower portion 370 of the display panel 320 is touched by a user, the light 380 emitted at an angle α is stopped and is reflected or scattered from a finger 360 rather than the frame 340.

Therefore, the distance between the scanning apparatus 310 and the position at which the light 380 is reflected becomes shorter than the distance between the scanning apparatus 310 and the position of the frame 340 indicated by the light.

Such a change in distance is generated when the display panel 320 is touched and is measured and output by the detector 330, thereby making it possible to calculate the touched position using thereof.

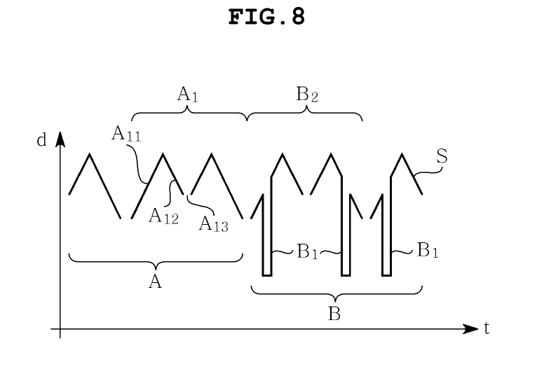

An example of the change in distance that is measured and output by the detector 330 is shown in FIG. 8. In FIG. 8, the distance d between the scanning apparatus 310 and the position at which light is reflected is measured according to time t.

A first section A of distance S shows the distance d measured before the display panel 320 is touched.

The section A1 of the measured distance shows the distance measured for one scan period by the light 350, wherein the scan period starts from the left-upper edge to the right-lower edge, and from the right-lower edge to the left-upper edge in FIG. 7. The section A11 of the distance S is recorded due to the scanning at the long side (horizontal side) of the display panel 320 and the section A12 of the signal S is recorded due to the scanning at the short side (vertical side) of the display panel 320. The gap A13 when any signal is not detected shows when the light collides with the absorption surface that may be used in showing the positions to change the scan direction. The distance recorded before the display panel 320 is touched may be used in correcting the distance read-out when the display panel 320 is touched.

The next section B of the distance S shows the distance measured while the display panel 320 is touched. The section B2 of the signal is recorded while the light is completely scanned over the display panel 320. As can be appreciated, the distance S shows a lower peak B1 due to the shorter distance measured by the reflection of light of the touch input member, such that it is changed in the period B as compared to the period A. The shorter distance shows a distance between the touch input member and the detector 330. The time length of the peak B1 shows a radius of the touch input member touching the display panel 320 devised by the distance of the detector 330, meanwhile, the position thereof is a measured value of the angle of the touch input member with respect to the edge of the display panel 320 on which the scan apparatus 310 is positioned. In such a manner, the angle of the touch input member with respect to the edge may be corrected.

An absolute touched position, that is, x and y coordinates, may be calculated from the angle and the distance of the light. The information on the distance generated while measuring the distance of the frame 340 may be used in correcting the angle of the light. When the touch input member is detected, an average between the light angles before pressing the touch input member and after pressing the touch input member is a favorable measured value with respect to the light angle while pressing the touch input member.

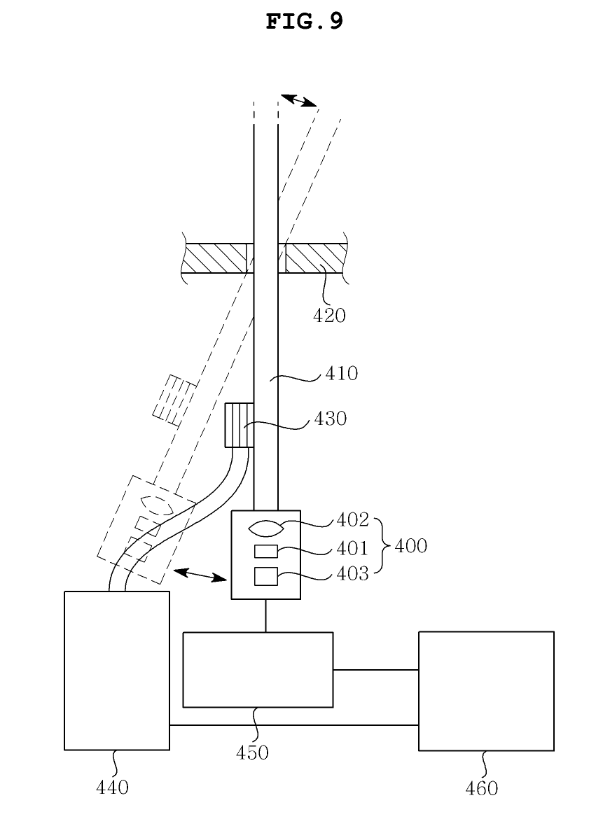

A preferred embodiment of the scanning apparatus 310 including electronic equipment is shown in FIG. 9.

FIG. 9 is a detailed configuration diagram of a scanning apparatus including the electronic equipment of FIG. 7.

As shown in FIG. 9, the scanning apparatus including the electronic equipment is configured to include a light source and detecting unit 400, an optical fiber 410, a support 420, a driving body 430, a driving body driver 440, a light source driving unit 450, and a signal processor 460. Herein, the light source and detecting unit 400 includes a light source 401, a lens 402, and a detector 403.

In this configuration, the light source 401 is driven by light source driving unit 450 to generate and emit current-modulated light.

The detector 403 receives reflection light emitted from the light source 401 and scattered and reflected from the frame or the touch input member to measure and output the distance of the frame or the touch input member to the signal processor 460.

The optical fiber 410 emits the light generated from the light source 401, the light having an emission angle periodically changed as indicated by an arrow due to the driving of the driving body 430.

The support 420 provides a rotation shaft to the optical fiber 410, thereby allowing the optical fiber 410 to be rotated by the driving of the driving body 430.

Then, the driving body 430 includes a piezo driving body that is driven by the driving body driver 440 and generates rotatory force capable of periodically changing the optical fiber 410 driven and touched by the driving body driver 440 as indicated by an arrow.

The driving body driver 440 applies voltage periodically changed to an upper electrode layer and a lower electrode layer of the piezo driving body constituting the driving body 430, thereby allowing the driving body 430 to generate rotatory force capable of periodically changing the optical fiber 410.

Meanwhile, the light source driving unit 450 controls the light source 401 to generate and emit current-modulated light.

The signal processor 460 calculates the touched position of the touch input member using the emission angle of the optical fiber 410 and the distance measured by the detector 403.

In this configuration, the light source 401 is driven by the light source driving unit 450 to generate and emit the light 350 or 380 of which path is changed by the optical fiber 410 mounted on the driving body 430 electrically driven, after penetrating through the lens 402. At this time, the light source 401 generates and emits the light current-modulated by the control of the light source driving unit 405 to have different frequencies as time elapses.

Then, the detector 403 receives reflection light emitted from the light source 401 and scattered and reflected from the frame or the touch input member to measure and output the distance of the frame or the touch input member to the signal processor 460.

In this case, when the light source 401 is a laser diode and the laser diode is used as the detector 403, if the laser diode receives the light scattered and reflected by the touch input member is received by the laser diode, it modulates the generated light. The detector 403 measures and outputs the distance between the laser diode and the touch input member using such a modulation (undulation).

The signal processor 460 calculates the touched position of the touch input member using the emission angle of the optical fiber 410 and the distance measured by the detector 403.

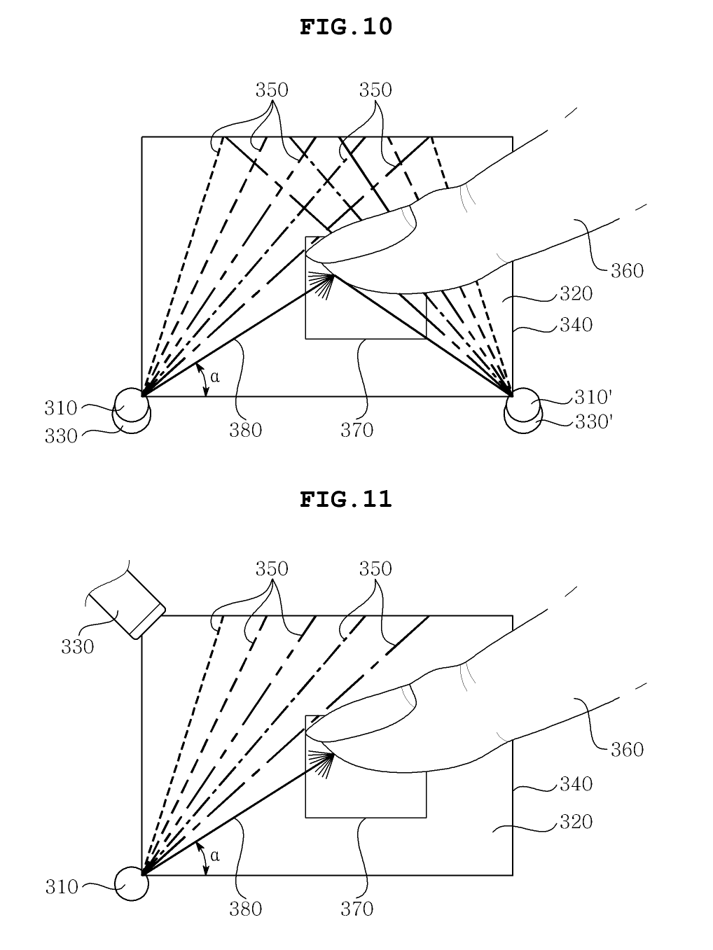

FIG. 10 is a configuration diagram of a touch screen using a scanning apparatus according to a second embodiment of the present invention.

The touch screen using the scanning apparatus according to the second embodiment shown in FIG. 10 is different from the touch screen using the scanning apparatus according to the first embodiment shown in FIG. 7 in that the scanning apparatuses 310 and 310′ are provided at both sides of the edge. Therefore, the detectors 330 and 330′ installed adjacent to the scanning apparatuses 310 and 310′ are also provided at both sides of the edge.

As described above, the plurality of scanning apparatuses 310 and 310′ and detectors 330 and 330′ are used in the touch screen, thereby making it possible to more accurately detect the position of the touch input member. In this connection, other constitutions and operations are the same as those of the touch screen according to the first embodiment shown in FIG. 7, such that a detailed description thereof will be omitted.

FIG. 11 is a configuration diagram of a touch screen using a scanning apparatus according to a third embodiment of the present invention.

The touch screen using the scanning apparatus according to the third embodiment of the present invention shown in FIG. 11 is different from those shown in FIGS. 7 and 10 in that the detector 330 is separated from the scanning apparatus 310 and installed at other edge of the frame 340. If the scanning apparatus 310 is separated from the detector 330 as described above, it is possible to perform a simple process in processing a signal.

In connection with the third embodiment of the present invention, other constitutions and operations are the same as those of the touch screen according to the first embodiment shown in FIG. 7, such that a detailed description thereof will be omitted.

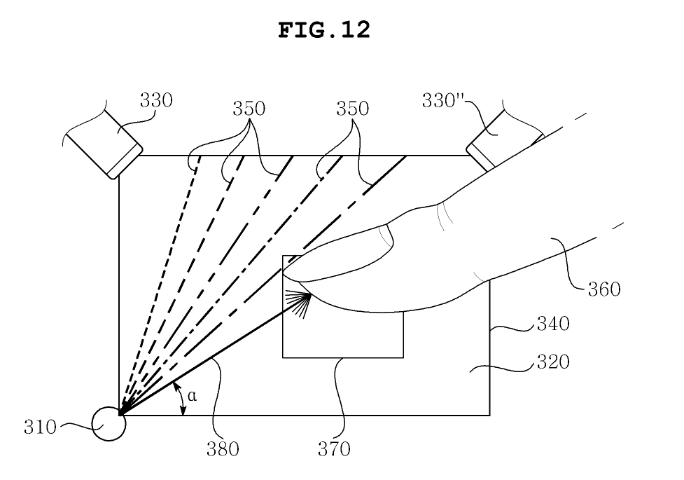

FIG. 12 is a configuration diagram of a touch screen using a scanning apparatus according to a fourth embodiment of the present invention.

The touch screen using the scanning apparatus according to the fourth embodiment of the present invention shown in FIG. 12 is different from that shown in FIG. 11 in that two detectors 330 and 330″ are separated from the scanning apparatus 310 and installed at both edges of the frame 340. The plurality of detectors 330 and 330″ are provided as described above, thereby making it possible to more accurately measure the position.

In connection with the fourth embodiment of the present invention, other constitutions and operations are the same as those of the touch screen according to the first embodiment shown in FIG. 7, such that a detailed description thereof will be omitted.

According to the present invention, light is emitted using the scanning apparatus instead of the plurality of infrared LEDs, thereby making it possible to manufacture the touch screen with a simple structure and at low installation costs while being easily installed.

In addition, according to the present invention, the area on which the scanning apparatus is mounted is limited to the edges of the frame, thereby making it possible to minimize the area occupied by the light source in the structure of the touch screen.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A scanning apparatus, comprising:
a light source that generates and emits light;
an optical fiber of which one end is connected to the light source to provide a transmission line through which the light emitted from the light source is transmitted;
a support that supports the side surface of the optical fiber to provide a rotation shaft so that the optical fiber is rotated; and
a driving body that is positioned between the support and the light source to provide driving force rotating the optical fiber using piezoelectric force.

2. The scanning apparatus as set forth in claim 1, further comprising a detector that is installed adjacent to the light source and receives light reflected from an object of which distance is to be measured through the optical fiber to measures and output a distance.

3. The scanning apparatus as set forth in claim 1, wherein the support is formed of a plate-shaped supporting plate that has a hole through which the optical fiber penetrates, the supporting plate formed around the hole supporting the side surface of the optical fiber to rotate the optical fiber.

4. The scanning apparatus as set forth in claim 1, wherein the support is formed of a plurality of supporting blocks that are spaced apart from each other having a gap through which the optical fiber penetrates, the supporting blocks having a concave shape on a surface opposite to a surface through which the optical fiber penetrates.

5. The scanning apparatus as set forth in claim 1, wherein the driving body includes
a substrate; and
a piezo driving body that is stacked on the substrate and provides driving force by the piezoelectric force.

6. The scanning apparatus as set forth in claim 5, wherein the piezo driving body includes:
a first electrode layer that is stacked on the substrate, the first electrode layer being made of a conductive material;
a piezo layer that is stacked on the first electrode layer, the piezo layer being made of a piezo material; and
a second electrode layer stacked on the piezo layer, the second electrode layer being made of a conductive material.

7. A touch screen, comprising:
a display panel that emits light and implements an image;
a first scanning apparatus that emits light periodically scanned over the surface of the display panel to the display panel in parallel and adjacent thereto; and
a first detector that receives light reflected or scattered from the touch input member in contact or adjacent to the display panel to calculate and output a distance,
wherein the first scanning apparatus includes:
a first light source that generates and emits light;
a first optical fiber of which one end is connected to the first light source to provide a transmission line through which the light emitted from the light source is transmitted;
a first support that supports the side surface of the first optical fiber to provide a rotation shaft so that the first optical fiber is rotated; and
a first driving body that is positioned between the first support and the first light source to provide driving force rotating the first optical fiber using piezoelectric force.

8. The touch screen as set forth in claim 7, further comprising a second detector that receives the light reflected or scattered from the touch input member in contact or adjacent to the display panel to calculate and output a distance.

9. The touch screen as set forth in claim 7, wherein the first detector is installed in the first scanning apparatus to be adjacent to the first light source and receives incident light through the first optical fiber to measure and output the distance of the touch input member.

10. The touch screen as set forth in claim 7, wherein the first driving body includes:
a substrate;
a first electrode layer that is stacked on the substrate, the first electrode layer being made of a conductive material;
a piezo layer that is stacked on the first electrode layer, the piezo layer being made of a piezo material; and
a second electrode layer stacked on the piezo layer, the second electrode layer being made of a conductive material.

11. The touch screen as set forth in claim 7, further comprising a signal processor that confirms the distance of the touch input member output from the first detector and the emission angle of the first scanning apparatus to determine the position of the touch input member.

12. The touch screen as set forth in claim 7, further comprising a second scanning apparatus that is spaced apart from the first scanning apparatus and emits light periodically scanned over the display panel to the display panel in parallel and adjacent thereto,
wherein the second scanning apparatus includes:
a second light source that generates and emits light;
a second optical fiber of which one end is connected to the second light source to provide a transmission line through which the light emitted from the light source is transmitted;
a second support that supports the side surface of the second optical fiber to provide a rotation shaft so that the second optical fiber is rotated; and
a second driving body that is positioned between the second support and the second light source to provide driving force rotating the second optical fiber using piezoelectric force.

13. The touch screen as set forth in claim 12, further comprising a third detector that is spaced apart from the first detector and receives the light reflected or scattered from the touch input member in contact or adjacent to the display panel to calculate and output the distance of the touch input member.

14. The touch screen as set forth in claim 13, wherein the third detector is installed in the second scanning apparatus to be adjacent to the second light source and receives incident light through the second optical fiber to measure and output the distance of the touch input member.

15. The touch screen as set forth in claim 14, further comprising a signal processor that confirms the distance of the touch input member output from the first detector and the third detector and the emission angle of the first scanning apparatus and the second scanning apparatus to determine the position of the touch input member.
